(19) United States
(12) Patent Application Publication
(10) Pub. No.: US 2026/0265940 A1
(43) Pub. Date: Sep. 10, 2026

(54) A FEEDWATER PREPARATION METHOD FOR ALKALINE ELETROLYSER SYSTEM AND A FEEDWATER PREPARATION SYSTEM

(71) Applicant: thyssenkrupp nucera AG & Co KGaA, Dortmund (DE)

(72) Inventors: Master Jullian Alexandar JOHANSSON, Kolding (DK); Jakob SKALLEBÆK, Kolding (DK); Henrik Kjær ANDERSEN, Kolding (DK)

(73) Assignee: thyssenkrupp nucera AG & Co KGaA, Dortmund (DE)

(21) Appl. No.: 19/472,519

(22) PCT Filed: Feb. 5, 2024
(86) PCT No.: PCT/EP2024/052789

§ 371 Date: Oct. 3, 2025

(30) Foreign Application Priority Data
Feb. 5, 2023 (DK) PA202300104

(51) Int. Cl. C25B 15/08; C25B 1/04; C25B 9/70

(52) U.S. Cl. CPC C25B 15/083; C25B 1/04; C25B 9/70

(57) ABSTRACT

A feedwater preparation system in a water electrolyser is adapted to produce hydrogen and oxygen in one or more pressurised electrolyser stacks using alkaline water and comprises a product gas conditioning system that has a safety valve out-blow material stream pipe which is connected to a feedwater vessel, and/or has a depressurisation stream pipe from a gas cleaning vessel which is connected to the feedwater vessel.

The present invention relates to a feedwater preparation method for alkaline water electrolysis system and a feedwater preparation system in a water electrolyser adapted to produce hydrogen and oxygen in one or more pressurized electrolyser stacks using alkaline water and comprising a product gas conditioning system

### BACKGROUND OF THE INVENTION

In water electrolysers that produce hydrogen and oxygen by splitting water, and especially in electrolysers that are pressurised and use an alkaline rich water solution as the electrolyte, it is desired, that the alkali part of the electrolyte remains within the electrolyser system and is not flushed out of the unit with the production gasses hydrogen and oxygen. In such systems today, design pressures up to 50 bar is common and system pressures around 35-40 bar is often seen. And system going up to 90-120 bars have been designed. The high pressure in such system allows for the produced gasses to leave the electrolyser unit at the system pressure, and the users of the gas or gasses are well pleased to receive the hydrogen or oxygen at an elevated pressure. Safety measures are needed such as safety valves to ensure that the pressure may be relieved if system or design pressures are surpassed due to failing valves or the like, and usually the out-blow material stream from such valves is relieved directly to the atmosphere. Attempts to capture alkali components and/or fluids in such blow-out material streams have failed. Also, when a system of this kind is set in a safe state, customarily nitrogen or a similarly inert gas is introduced into pipes and vessels in order for no traces of oxygen and hydrogen to remain in the plant. This so-named purging process may also flush alkali particles, which may have crystallized along certain lengths of piping, and this alkali component is usually lost, as all purging gasses are customarily vented off directly to the atmosphere. Further, such systems may comprise gas containing vessels at high pressure which needs to be depressurised to put the system into a safe state, and if such depressurisation gasses are vented to the atmosphere, traces of the alkali component may escape with such a gas stream.

### SUMMARY OF THE INVENTION

In an alkaline electrolyser system of the above kind, a feedwater preparation method is provided, wherein one or more electrolyser stacks each has at least one diaphragm separating an oxygen producing half-cell from a hydrogen producing half-cell and wherein further every oxygen producing half-cell delivers an oxygen-electrolyte mixture and every hydrogen producing half-cell delivers a hydrogen-electrolyte mixture, and whereby further each of said mixtures are separated in respective separators into a product gas stream of mainly oxygen and an oxygen depleted electrolyte stream and a product gas stream of mainly hydrogen and hydrogen depleted electrolyte stream, whereby the electrolyte streams are replenished with water from a feedwater vessel.

According to the invention, the feedwater vessel receives an out-blow material stream from at least one safety valve whenever the valve is active, and/or receives an out-blow material stream from depressurization of pressurized vessels holding a product gas whenever depressurization of the system is instigated.

If the safety valve in question is the separator vessel safety valve, the out-blow material stream therefrom is likely to contain a high proportion of alkali rich water mixed with the respective product gas. Once inside of the feedwater tank, it is relatively easy to provide the means for at least a partial separation between the fluid and gas part of such a material stream and retain the liquid part inside the feedwater vessel and thereby also retaining the alkali component of the stream.

A similar opportunity comes from the material stream that will naturally occur, when process vessels which are part of the gas conditioning line downstream of the separators, need to be depressurized. This need arises every time the system needs to be turned off and placed in a safe condition. And again, in order to avoid sending alkali elements to the environment outside of the system, the material stream stemming from a depressurization event is likewise piped into the feedwater tank, whereby the liquid comprising possible traces of alkaline components are easily trapped inside the feedwater vessel as are possible solid particles in the material stream.

In an embodiment, the out-blow material stream is directed tangentially onto an inner cylindrical surface inside the feedwater vessel and caused to form a cyclone whereby possible solids and liquids precipitate onto the inner cylindrical surface and further, gasses are caused to exit the vessel through an exit pipe arranged coaxially with a centre axis of the inner cylindrical surface.

The task of separation of liquid and/or solid elements from the gasses may be performed in any number of ways, however in the present case, where the out-blow material stream and/or the depressurization stream arrives with a considerable speed into the feedwater tank, the formation of a cyclone flow will be relatively easy to accomplish and take up less space relative to other types of separation methods.

In an embodiment of the feedwater preparation method, the feedwater vessel receives an alkali containing drain originating from filtering and drying processes performed on the respective product gas streams.

This provision again is instrumental in ensuring that any alkali containing substance is maintained within the system. A number of drains are usually embedded in the gas conditioning apparatus of the system, and each may supply a liquid material flow comprising at least traces of the alkali component from the electrolyte, a component which is best piped back into the feedwater vessel to ensure that the alkali part is not lost from the system. The return of the drains to the feedwater tank are also instrumental in keeping water consumption low and closer to the ideal minimum which corresponds to the produced hydrogen and oxygen.

In an embodiment of the feedwater preparation method, feedwater and possible alkali materials dissolved therein from the feedwater vessel is pressurized and used in a product gas cleaning process in a gas cleaning vessel wherein a possible alkaline substance carried in the product gas stream is dissolved in the pressurized feed water, and whereby the thus further alkaline enriched water is entered into the respective separator to replenish water lost during the electrolysis processes in the half-cells.

In the cleaning vessel, the product gas is mixed thoroughly with the fluid in the cleaning vessel whereby particles and/or droplets of the electrolyte and alkali component are caught within the cleaning vessel fluid. One way of accomplishing the mixing is by percolating small bubbles of the gas up through a column of liquid. In this case the liquid water originates from the feedwater tank and the water in the cleaning vessel will be further enriched with an alkaline content, whereby this alkaline component remains trapped within the system.

In an embodiment of the feedwater preparation method, a first feedwater vessel receives fluids and gasses from a hydrogen preparation system and delivers feedwater to a hydrogen gas cleaning process and a second feedwater vessel receives fluids and gasses from an oxygen preparation system and delivers feedwater to an oxygen gas cleaning process.

In some electrolyser systems, the gas depleted alkaline liquid flows from the gas separators are mixed prior to being re-injected into the electrolyser stack or stacks, and in such systems, the water from the cleaning vessels may be pumped into this mixed flow from the two separators. However, in the present case, there are two separate electrolyte flows: a hydrogen producing flow and an oxygen producing flow, and further to each product gas stream an equivalent gas conditioning process is arranged. And thus, to each conditioning process, a gas cleaning vessel is provided, which then deliver the alkaline enriched water flow to the respective separator. In this way, a minimum of cross-contamination between the gasses in the electrolytic fluids is ensured.

In an aspect, the objects of the invention are obtained by a feedwater preparation system in an alkaline water electrolysis system, which alkaline water electrolysis system is adapted to produce hydrogen and oxygen in one or more pressurized electrolyser stacks using alkaline water and wherein each stack has at least one diaphragm separating an oxygen producing half-cell from a hydrogen producing half-cell, whereby every oxygen producing half-cell is adapted to deliver an oxygen-electrolyte mixture, and every hydrogen producing half-cell is adapted to deliver a hydrogen-electrolyte mixture, whereby each of said mixtures are piped to respective separators and here separated into a product gas stream of mainly oxygen and an oxygen depleted electrolyte stream and a product gas stream of mainly hydrogen and hydrogen depleted electrolyte stream, whereby the electrolyte streams are replenished with water from a feedwater vessel, and wherein the alkaline water electrolysis system further comprises a product gas preparation system is provided.

According to this aspect of the invention, a safety valve out-blow material stream pipe is connected to a feedwater vessel and/or a depressurization stream pipe from a gas cleaning vessel is likewise connected to the feedwater tank.

Both the out-blow from a safety valve and the depressurization streams May comprise material which contains traces of the alkaline component of the electrolyte. And thus, connection between these two sources of alkaline material and the feedwater vessel ensures that less alkali material is lost from the system. The alkali component is customarily potassium or sodium. In the present case potassium is used.

In an embodiment of the feedwater preparation system, the safety valve pipe and material stream are tangentially connected to a cylindrical part in the feedwater vessel to expel a material stream along an inner cylindrical surface part in the feedwater tank, and further, an exit pipe is provided coaxially with the cylinder axis of the inner cylindrical surface part in the feedwater vessel and connected directly to the atmosphere.

This arrangement shall ensure a cyclone like flow pattern of the gasses and fluids added to the feedwater tank. And a cyclone like flow pattern shall help to ensure, that any solids or liquids within the material streams entering the feedwater vessel shall precipitate onto the cylindrical part in the feedwater vessel and from the cylindrical part flow through a cyclone opening and down into the liquid held in the feedwater tank, and thereby remain in the vessel and not be flushed out with the gas stream, which exits the vessel through the coaxially arranged pipe. The pressure difference between the arriving out-blow material and the low pressure in the feedwater vessel also ensures the cyclone effect. This low pressure in the feedwater vessel is maintained also by having an exit pipe therefrom which is open to the atmosphere, and which exit pipe has a flow area, which is at least several times larger than the flow area of the safety valve pipe. The low pressure maintained within the feedwater tank also ensures that alkali containing water in the tank will not at any circumstances flow back into a pure water pipe and a pure water treatment system which is also connected to the feedwater tank.

In an embodiment of the feedwater preparation system, the feedwater vessel is connected to drains from further gas conditioners in a gas preparation system.

By installing such further connections, it is ensured that only small amounts of the alkali component shall leave the system.

In an embodiment of the feedwater preparation system, a feedwater exit pipe from a lower part of the feedwater vessel is connected to a feedwater pressure pump and adapted to provide feedwater material stream into a gas cleaning vessel, and further, a pipe interconnects the gas cleaning vessel and a gas separator, whereby water from the feedwater vessel may be piped through the gas cleaning device to enter the gas separator as an alkali enriched water stream to thereby replenish water lost to the water electrolytic process, and to make sure, that any alkali substance, which may have escaped the gas separator vessels with the gas streams is returned to the electrolytes of the system.

The pressure pump is inserted in the pipe between the feedwater vessel and the gas cleaning vessel as the feedwater vessel is open to the atmosphere and thus maintained at ambient pressure, whereas the gas cleaning vessel is maintained at system pressure whereby the pressure pump will increase the pressure in the feedwater material stream which feeds into the gas cleaning vessel. The fluid stream from the gas cleaning vessel and into the separator ensures that any alkali component washed out of the production gas is returned into the electrolyte streams in and out of the stacks.

In an embodiment of the feedwater preparation system, a first feedwater vessel is connected to drains and filters of a hydrogen gas preparation system and is further connected to a hydrogen gas cleaning vessel for supply of water thereto and further a second feedwater vessel is connected to drains and filters of an oxygen gas preparation system and the second feedwater vessel is further connected to an oxygen gas cleaning vessel for supply of water thereto.

Using a feedwater vessel in both the hydrogen and the oxygen gas cleaning systems ensures that no alkaline component is flushed out of the system. In many instances, the oxygen gas which is produced is not used for any industrial purpose but released to the atmosphere. However, cleaning of this production gas may still be required, and it is thus advantageous to reclaim any alkaline parts which escape the separation process with the produced oxygen.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

It should be emphasized that the term “comprises/comprising/comprised of” when used in this specification is taken to specify the presence of stated features, integers, steps or components but does not preclude the presence or addition of one or more other features, integers, steps, components or groups thereof.

### LIST OF FIGURES/BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 is a flow diagram with feedwater vessel and main components and material flows relating to the vessel indicated,

FIG. 2 shows a horizontal sectional view from above of a feedwater tank,

FIG. 3 shows a vertical sectional 3D view of the tank,

FIG. 4 shows a principal outline of a sectional view of a tangential inflow path,

FIG. 5 is a schematic representation of an alkaline water electrolysis system,

FIG. 6 is an idealized representation of a built-in cyclone inside of the feedwater tank,

FIG. 7 shows a schematic representation of an electrolyser having only a single cell 22 and

FIG. 8 shows an electrolyser system as displayed in FIG. 5 but including only the hydrogen conditioning part of the system.

### DETAILED DESCRIPTION OF THE EMBODIMENTS

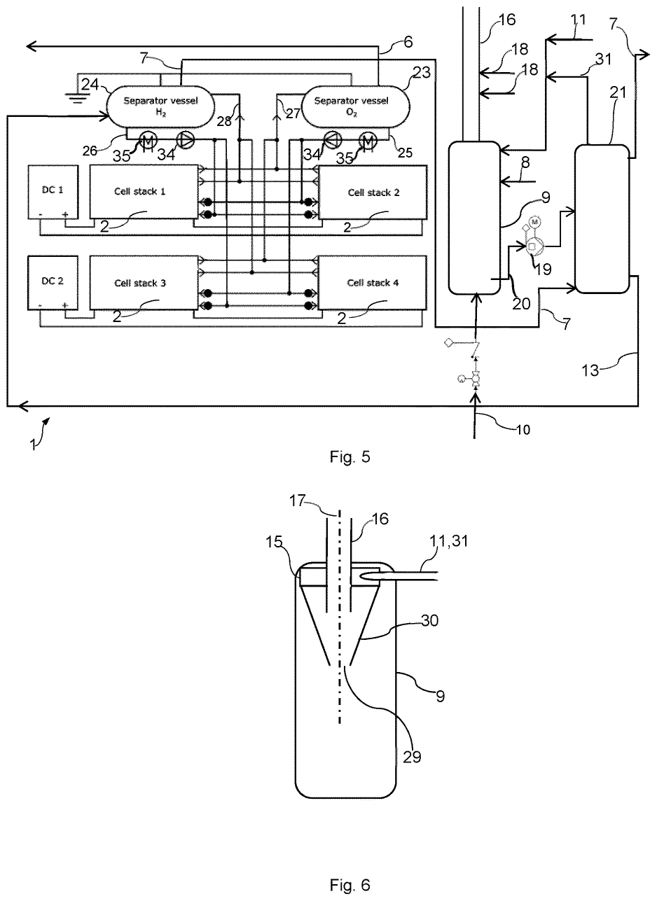

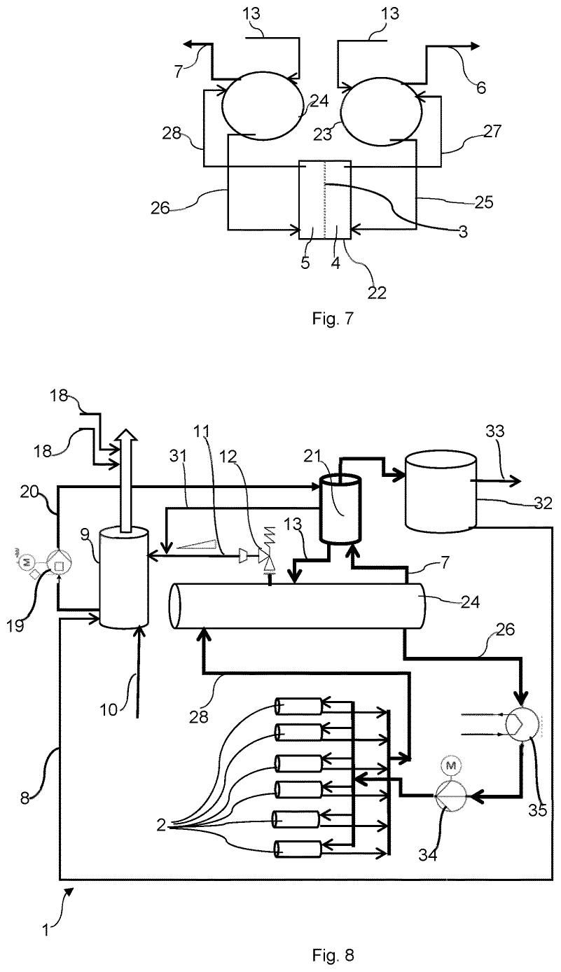

In FIG. 5 some of the major components of an alkaline water electrolysis system 1 are schematically represented. Four electrolyser stacks 2 marked “Cell stack 1”, “Cell stack 2”, “Cell stack 3” and “Cell stack 4”, respectively, are shown. Each cell stack 2 comprises a number of single cells 22. In FIG. 7 illustrates one such cell is schematically seen. Each single cell 22 comprises an oxygen producing half cell 4 and a hydrogen producing half cell 5, and a diaphragm 3 which separates the two half cells 4,5 and ensures that the gasses, i.e. oxygen and hydrogen, produced gasses by the cell 22 are not mixed. The electrolyser stacks 2 shall preferably comprise a predetermined number of cells 22, and the electrolyte and product streams in and out of the cells 22 in each stack 2 shall be piped to each half cell 4,5 through four stack internal manifolds (not shown) as is well-known in the art.

As seen in FIG. 5, stack external delivery manifolds shall pipe the deliveries of oxygen product gas and electrolyte mixture 27 as well as hydrogen product gas and electrolyte mixture 28 from each stack 2 to the respective separator vessel 23, 24. Similar feed manifolds shall ensure that the gas depleted electrolyte 25, 26 is returned to the stacks 2. The stack external manifold structure is seen in FIG. 5 situated between the stacks, and this manifold structure allows for the four stacks 2 to be driven with only two common separator vessels 23,24. Any number of stacks may be used with two separators but increasing piping lengths will usually be a limitation and in an embodiment as shown if FIG. 8, six stacks 2 are disclosed along with one separator 24. A second separator 23 will also have to be part of such a system but is not shown in FIG. 8.

The electrolyte to be fed to the stacks 2 is replenished with alkaline enriched water 13, which is piped to the separators 23, 24 from respective gas cleaning vessels. In FIG. 5 and FIG. 8, the gas cleaning vessel 21 is shown, which receives a hydrogen product gas stream 7 from the hydrogen separator vessel 24, and exits the same hydrogen product gas stream 7, but now virtually freed from traces of the alkaline content from the electrolyte. The alkaline content in the hydrogen (and oxygen) product gas streams 7,6 which originates directly from the separators 23,24 is too high for most uses of the hydrogen and oxygen product gas, but by capturing this alkali content in a water phase in the gas cleaning vessel 21, the product gasses shall be free of this alkaline content and by further feeding the thereby alkaline enriched water 13 from the cleaning vessel 21 to the separator 24 to replenish the water lost in the electrolyses process, the alkali component in the electrolyte streams shall remain inside the alkaline water electrolysis system 1.

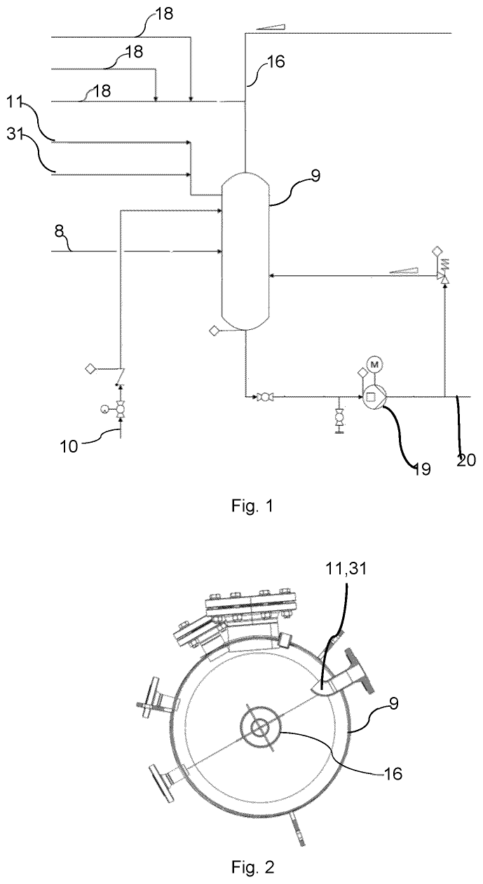

In FIGS. 8, 5 and 1, the feedwater vessel 9 is disclosed, and this vessel 9 is the recipient of the out-blow material stream 11 from a safety valve 12 from the hydrogen gas treatment system, and also the recipient of one or more fluid drain outflows 8 originating from the hydrogen gas treatment. The feedwater vessel 9 also delivers feedwater 20 to the hydrogen gas cleaning vessel 21, and a further alkali enriched water stream 13 is piped from the gas cleaning vessel 21 into the hydrogen gas separator 24 as mentioned above.

Similarly, the oxygen gas separator vessel 23 shall be installed in such a way that it pipes oxygen to an oxygen cleaning vessel (not shown, but corresponding to cleaning vessel 21 for hydrogen, and connected to the oxygen separator vessel 23) and, through this oxygen cleaning vessel, further connected to an oxygen feedwater vessel (not shown, but corresponding to hydrogen feedwater vessel 9 and delivering water to the oxygen cleaning vessel) which oxygen feedwater vessel shall be the recipient of gas and/or water streams originating from the treatment of the oxygen, and among those the out-blow material streams from one or more safety valves in an oxygen treatment system such as a safety valve (not shown) on the oxygen gas separator 23.

In any closing down of the system, depressurisation is required for safety reasons, and vessels, such as the gas cleaning vessel 21 also needs to be depressurised. This will produce a material stream 31 which will contain traces of water from the cleaning vessel 21, and thereby some traces of the alkaline content in the electrolytes used. Thus, this stream 31 is also added to the flow line or pipe 11 originating from the safety valve 12 on the separator in question. This is seen in FIG. 8 and FIG. 5.

Both hydrogen and oxygen product gasses are treated in a number of steps, the first being the separation step in the separators 23,24 and the next being gas cleaning in respective gas cleaning vessels, and following this, further gas conditioners like filters, dryers and coolers, illustrated by vessel 32 in FIG. 8 for the hydrogen side, may be used to secure gas delivery 33 out of the system in accordance with a given customer's quality requirements, or environmental requirements in case the recipients of a gas such as oxygen is the atmosphere. Some of these processes, such as the drying, will result in by-products such as water containing traces of the alkali component. All such by-products may now safely be piped back to the respective feedwater vessel to thereby ensure, that no alkali component is lost through the gas stream 33 delivered to a customer.

A pure water supply line 10 is arranged to pipe pure water into the feedwater vessel 9 to make up for the consumption of water in the electrolysis system. The water has undergone a treatment to deplete it from non-water substances such as calcium and other pollutants, as such pollutants may accumulate in the system. The feedwater vessel 9 is directly connected to the atmosphere through the coaxially arranged exit pipe 16, and thus the pure water supply 10 may operate at a pressure only slightly above atmospheric such as 1 bar above atmospheric pressure and still remain protected against possible flow back of alkaline containing water from the feedwater vessel 9.

Any out-blow material streams 11,31 arriving from a safety valve or depressurisation process may however arrive at or even above the system pressure in the pressurised stacks, separator vessels and gas treatment systems, and thus the feedwater vessel 9 should ideally be dimensioned to withstand such high pressures.

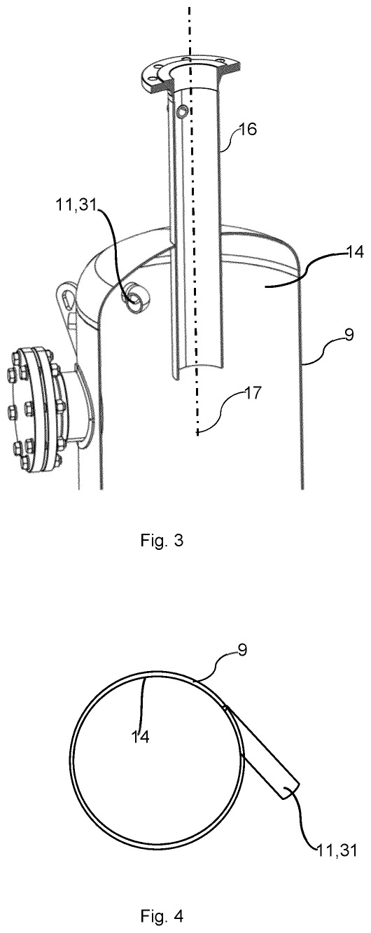

In FIGS. 2 and 3, a top part of the feedwater vessel 9 is shown, and as seen, this part has an inner cylindrical surface 14. A pipe stub indicates the access point of a material stream 11,31 directed into the vessel 9, and the pipe stub has an angled exit opening which is intended to give the material stream an inflow direction tangential to the cylindrical surface part 14. Thereby the creation of a vortex or cyclone material stream along the cylindrical surface part 14 is intended. In FIG. 4, a somewhat more elaborate tangential flow entry of material stream 11 into the cylindrical part of the feedwater vessel is shown. By this design, more particles and fluid are likely to precipitate onto the inner cylindrical surface of the vessel 9. The desired cyclone effect is in both cases enhanced by the exit pipe 16, which is placed to have its centre axis 17 arranged coaxially with the cylinder axis of the cylindrical part 14, 15 in the vessel 9. Preferably the exit pipe extends down into the vessel 9 and has a lowermost edge which is extended to a point somewhat below the entry point of the material stream 11 but is above the water level of the feed water vessel 9.

In FIG. 6, the cylindrical surface 15 is schematically shown as an inserted element in the vessel 9, and as seen in the figure, the insert has a narrowing downwardly directed cone-like portion 30 ending in a cyclone exit 29 into the feedwater vessel 9. By way of the cone-like portion or cyclone surface 30, the material stream 11 directed onto the cylindrical surface 15 in a tangential manner shall rotate with increasing speed towards the exit 29. This enhances precipitation of material parts which has a higher density than the gas phase in the material stream 11,31. The exit pipe 16 is arranged coaxially with the cylindrical surface 15, and in this embodiment, it does not need to be aligned with the length axis of the feedwater vessel 9. Preferably, the pipe 16 has a lowermost extend that is somewhat above the exit opening 29 of the cone-shaped cyclone-enhancing surface 30. The advantage of this embodiment is that any obstacles to the cyclone-like rotation of the material stream 11,31 on an inside surface of the feedwater vessel 9, such as an inspection opening or further inlets into the vessel will not cause a disturbance to the cyclone flow along the inner cyclone surface 30 and/or the cylindrical part 15 inside of the feedwater vessel 9.

The safety valve 12 is schematically disclosed in FIG. 8. Also, a main pump 34 which may drive the stream of alkali electrolyte stream 26 and the hydrogen product gas and electrolyte stream 28 to/from the array of stacks 2 is shown. Heat exchangers 35 are inserted in the electrolyte stream between separators 24, 23 and the stacks 2 to ensure that the stacks receive the electrolytes at constant temperature.

A feedwater pressure pump 19 is shown in FIG. 8 and FIG. 5 and this pump is adapted to elevate the pressure of the feedwater out of the feedwater vessel to system pressure, such that this water may now be entered into the cleaning vessel 21 at system pressure.

At present, alkaline water electrolysers are driven at pressures between 30 and 40 bar. However, it is expected that system running at pressures up to 120 bars will be used in the future.

It is to be noted that the figures and the above description have shown the example embodiments in a simple and schematic manner. Many of the specific mechanical details have not been shown since the person skilled in the art should be familiar with these details and they would just unnecessarily complicate this description.

List of parts

| | |
|---|---|
| 1. | alkaline water electrolysis system |
| 2. | electrolyser stack |
| 3. | diaphragm |
| 4. | half cell/Oxygen producing half-cell |
| 5. | half cell/Hydrogen producing half-cell |
| 6. | Oxygen product gas stream |
| 7. | Hydrogen product gas stream |
| 8. | fluid drain outflow |
| 9. | feedwater vessel |
| 10. | pure water supply |
| 11. | out-blow material stream |
| 12. | safety valve |
| 13. | Alkali enriched feedwater stream |
| 14. | cylindrical part in feedwater tank |
| 15. | inner cylindrical surface |
| 16. | coaxially arranged exit pipe |
| 17. | centre axis of the cylindrical part in feed water tank |
| 18. | excess gas streams |
| 19. | feedwater pressure pump |
| 20. | feedwater material stream and exit pipe |
| 21. | gas cleaning vessel |
| 22. | single cell (of a cell stack) |
| 23. | Oxygen gas separator |
| 24. | Hydrogen gas separator |
| 25. | Oxygen depleted electrolyte stream |
| 26. | Hydrogen depleted electrolyte stream |
| 27. | Oxygen product gas and electrolyte mixture |
| 28. | Hydrogen product gas and electrolyte mixture |
| 29. | cyclone exit |
| 30. | cyclone surface |
| 31. | gas cleaning vessel depressurisation stream |
| 32. | further gas conditioners |
| 33. | gas delivery |
| 34. | main pump |

1.-10. (canceled)

11. A feedwater preparation method for an alkaline water electrolysis system, the alkaline water electrolysis system including one or more electrolyser stacks, wherein each stack has at least one diaphragm separating an oxygen producing half-cell from a hydrogen producing half-cell, the method comprising:
delivering, by every oxygen producing half-cell, an oxygen-electrolyte mixture, and delivering, by every hydrogen producing half-cell, a hydrogen-electrolyte mixture, wherein each of said mixtures are piped to respective separators and here separated into a product gas stream of mainly oxygen and an oxygen depleted electrolyte stream and a product gas stream of mainly hydrogen and hydrogen depleted electrolyte stream, wherein the electrolyte streams are replenished with water from a feedwater vessel;
wherein the alkaline water electrolysis system further includes a product gas conditioning system, wherein the feedwater vessel receives an out-blow material stream from at least one safety valve whenever the valve is active, and/or receives an out-blow material stream from depressurisation of a pressurized gas cleaning vessel of the product gas conditioning system, the gas cleaning vessel holding a product gas, whenever depressurisation of the system is instigated.

12. The feedwater preparation method according to claim 11, wherein the out-blow material stream is directed tangentially onto an inner cylindrical surface inside the feedwater vessel and caused to form a cyclone whereby possible solids and liquids precipitate onto the inner cylindrical surface and gasses are caused to exit the vessel along an exit pipe arranged coaxially with a center axis of the inner cylindrical surface.

13. The feedwater preparation method according to claim 11, wherein the feedwater vessels receive an alkali containing fluid drain outflow originating from filtering and drying processes performed on the respective product gas streams.

14. The feedwater preparation method according to claim 11, wherein feedwater and possible alkali materials dissolved therein from the feedwater vessel is pressurised and used in a product gas cleaning process in a gas cleaning vessel wherein a possible alkaline substance carried in the product gas stream is dissolved in the pressurised feed water, and the thus further alkaline enriched water is entered into one of the separators to replenish water lost during the electrolysis processes in the half-cells.

15. The feedwater preparation method according to claim 11, wherein a first feedwater vessel receives fluids and gasses from a hydrogen preparation system, and delivers feedwater to a hydrogen gas cleaning process and a second feedwater vessel receives fluids and gasses from an oxygen preparation system and delivers feedwater to an oxygen gas cleaning process.

16. A feedwater preparation system in an alkaline water electrolysis system, wherein the alkaline water electrolysis system is adapted to produce hydrogen and oxygen in one or more pressurised electrolyser stacks and wherein each stack has at least one diaphragm separating an oxygen producing half-cell from a hydrogen producing half-cell, wherein every oxygen producing half-cell is adapted to deliver an oxygen-electrolyte mixture, and every hydrogen producing half-cell is adapted to deliver a hydrogen-electrolyte mixture, wherein each of said mixtures are piped to respective separators and here separated into a product gas stream of mainly oxygen and an oxygen depleted electrolyte stream and a product gas stream of mainly hydrogen and hydrogen depleted electrolyte stream, wherein the electrolyte streams are replenished with water from a feedwater vessel, and wherein the alkaline water electrolysis system further comprises a product gas conditioning system, wherein a safety valve out-blow material stream pipe is connected to a feedwater vessel, and/or a depressurisation stream pipe from a gas cleaning vessel of the product gas conditioning system is connected to the feedwater vessel.

17. The feedwater preparation system according to claim 16, wherein the safety valve pipe and material stream and/or depressurisation stream pipe is tangentially connected to a cylindrical part in the feedwater vessel to expel a material stream along an inner cylindrical surface part in the feedwater vessel, and further, an exit pipe is provided coaxially with the cylinder axis of the inner cylindrical surface part in the feedwater vessel and connected directly to the atmosphere.

18. The feedwater preparation system according to claim 16, wherein the feedwater vessel is connected to drains from further gas conditioners in a gas preparation system.

19. The feedwater preparation system according to claim 16, wherein a feedwater exit pipe from a lower part of the feedwater vessels is connected to a feedwater pressure pump and adapted to provide feedwater material stream into a gas cleaning vessel, and further, a pipe interconnects the gas cleaning vessel and a gas separator, whereby water from the feedwater vessel may be piped through the gas cleaning device to enter the gas separator as an alkali enriched water stream to thereby replenish water lost to the water electrolytic process.

20. The feedwater preparation system according to claim 16, wherein a first feedwater vessel is connected to drains and filters of a hydrogen gas preparation system and is further connected to a hydrogen gas cleaning vessel for supply of water thereto and a second feedwater vessel is connected to drains and filters of an oxygen gas preparation system and is further connected to an oxygen gas cleaning vessel for supply of water thereto.
